(19) United States
(12) Patent Application Publication
(10) Pub. No.: US 2005/0039701 A1
(43) Pub. Date: Feb. 24, 2005

(54) Pet restraint apparatus

(76) Inventors: Jack R. Jerozal SR., Evergreen Park, IL (US); Robert Back, Mt. Prospect, IL (US)

Correspondence Address: Bell, Boyd & Lloyd LLC, P.O. Box 1135, Chicago, IL, 60690-1135, US

(21) Appl. No.: 10/639,270

(22) Filed: Aug. 12, 2003

(51) Int. Cl. A01K 1/04

(52) U.S. Cl. 119/788

(57) ABSTRACT

A pet restraint apparatus including a leash holder and a ground engager. The ground engager is adapted to be inserted into the ground. The leash holder is adapted to be removably inserted into the ground engager. The leash holder includes a body, a leash securing member and a centering member. The centering member is adapted prevent substantial movement of the leash holder when it is inserted into the ground engager. The ground engager includes a body, a ground engaging member and a retainer. The retainer prevents undesired removal of the leash holder from the ground engager. The ground engager can also include a stopping member which controls the depth of insertion of the ground engager into the ground. The pet restraint apparatus can also include a mounting or locating plate for such purpose and for helping a user to locate the ground engager.

### BACKGROUND OF THE INVENTION

Many pet owners desire to maintain their pets, such as dogs, in an outdoor environment where the pets are allowed to roam and play within the boundaries provided by a restraint, and without constant attention by the pet owners. Certain apparatus and methods for restraining a pet to certain areas have been in existence since animals were first domesticated. Conventional methods of restraint are deficient in many respects. For instance, stakes mounted in the ground tend to be hidden from view and pose a serious tripping or mowing hazard to the unwary. Such stakes also tend to be cumbersome to set up and take down, forgotten, and if anchored deep enough into the ground, may never be used again. In addition, many of the conventional stakes do not achieve their primary function of providing controlled mobility to the animal and are often equipped with surfaces that catch or otherwise cause a tightening of the leash which holds the pet. Once the leash catches on the restraint, it is usually just a matter of time before the leash winds around itself until the animal is no longer able to move.

A pet restraint should serve at least two critical functions. First, it should restrain the animal within a certain defined boundary. Second, it should allow the animal to move freely within such boundary. From a human perspective, the restraint should also be easy to use, sturdy in design and easy to locate while inserted into the ground. As noted above, one of the major shortcomings of conventional methods of restraint is the problem of entanglement caused by constructional limitations or improper use of the restraint. Another problem of conventional methods of restraint is the hazards to people and lawn care equipment that these stakes may cause if not properly removed prior to use of the ground surrounding such stakes. Accordingly, there is a need for a pet restraint apparatus that is tangle free and is easily disassembled to avoid hazards to people and lawn care equipment.

### SUMMARY OF THE INVENTION

The present invention provides a pet restraint apparatus that is strong, relatively easy to install, portable and easily assembled and disassembled.

In one embodiment, the pet restraint apparatus includes a ground engager and a leash holder. The ground engager is adapted to be removably inserted into the ground. Once inserted into the ground, the ground engager remains inserted until it is removed by a person. The ground engager is adapted to removably receive and securely hold the leash holder. The leash holder is adapted to hold a leash or other suitable device which is attached to a pet. Once assembled, the leash holder is freely rotatable within the ground engager and thus substantially eliminates tangling of the leash and allows the pet controlled freedom of movement over a 360° area around the ground engager. The leash holder remains engaged with the ground engager until a person disassembles the pet restraint apparatus by disengaging the leash holder and removing it from the ground engager.

Since the leash holder is removably inserted into the ground engager, the pet restraint apparatus can be easily and conveniently disassembled to allow full use of the surrounding ground. For example, prior to mowing or other lawn care, a person can disassemble the pet restraint apparatus by removing the leash holder from the ground engager while the ground engager remains inserted into the ground. Once removed, the person can mow over the ground engager without damage to the blades of the lawn mower. After mowing, the person can easily and quickly reinsert the leash holder into the ground engager for subsequent pet restraining use.

In one embodiment, the pet restraint apparatus of the present invention also includes a mounting plate. The mounting plate is adapted to be positioned on the ground and the ground engager is inserted through the mounting plate into the ground. The mounting plate keeps the top of the ground engager a predetermined distance above the ground. The mounting plate also functions as a locator to enable a person to easily locate the ground engager. It should be appreciated that the present invention can be employed without the mounting or locating plate.

In one embodiment, the ground engager includes a body, a ground engaging member attached to one end of the body, and a retainer and a stopping member attached to the other or opposite end of the body. In one embodiment, the body is formed from a tubular sleeve or receiver adapted to receive the leash holder. The ground engaging member is crimped or otherwise formed to be inserted into the ground. The retainer retains the leash holder in the ground engager until a user desires to remove the leash holder from the ground engager. The stopping member is adapted to co-act with the mounting plate to control the insertion of the ground engager into the ground to a desired depth.

In one embodiment, the leash holder includes an elongated member or body such as a solid rod or shaft, a leash securing member attached to one end of the member or body and a centering member attached to the other or opposite end of the member or body. In one embodiment, the body is an elongated cylindrical rod wherein the leash securing member and centering member are formed from opposite ends of the rod by suitably bending the rod at the opposite ends. The leash securing member transversely extends from the member at a certain angle or direction and is adapted to hold or engage a leash which holds a pet. The centering member transversely extends from the body at an opposite angle or direction of the leash securing member. That is, in one embodiment, the leash securing member is bent in one direction and the centering member is bent in an opposing direction. The leash holder of the present invention thus provides that regardless of the direction or force by which the leash securing member is pulled, once received by the ground engager, the leash holder will remain substantially vertically centered within the ground engager. Since the leash securing member and the centering member are bent in opposite directions, as the leash securing member is pulled in one direction, the centering member will engage the inside wall of the body of the ground engager to prevent substantial movement of the leash holder along the vertical axis. In one alternative embodiment, the leash holder does not include the centering member.

In one embodiment, the leash holder also includes a release inhibiting member which is attached to and transversely extends from the member or body substantially adjacent to the leash securing member. The release inhibiting member is adapted to engage the retainer of the ground engager to prevent the leash holder from being readily removed when the pet pulls the leash while enabling a user to easily remove the leash holder from the ground engager.

To assemble the embodiment of the pet restraint apparatus of the present invention which does not include a mounting or locating plate the, ground engager is positioned perpendicular to the ground and a force is applied to the ground engager to drive the ground engaging member into the ground. As the ground engaging member is driven into the ground, the attached body of the ground engager is driven into the ground. This process continues until the stopping member engages the ground and prevents the ground engager from further insertion into the ground. Once the ground engager is inserted, the stopping member end of the ground engager receives the centering member followed by the body of the leash holder. If the mounting plate is employed, the ground-engager is inserted into the ground through the mounting plate until the stopper engages the top of the mounting plate.

When the pet restraint apparatus is fully assembled, in one embodiment, the centering member of the leash holder is positioned in the body of the ground engager slightly above the end which is attached to the ground engaging member. This configuration provides that the leash holder is able to freely rotate within the ground engager. That is, as the pet moves around the pet restraint apparatus, the leash securing member moves with the pet to prevent entanglement of the leash and the pet restraint apparatus.

When the pet restraint apparatus is fully assembled, in one embodiment, the release inhibiting member engages the retainer of the ground engager to prevent the leash holder from being removed from the ground engager. In this embodiment, the release inhibiting member must be aligned with the aperture defined by the retainer to enable the release inhibiting member to be removed from the ground engager.

It should be appreciated that a pet owner may insert a plurality of ground engagers (and mounting plates) at different locations throughout their lawn or property and depending on where they are situated, transfer a single leash holder from one ground engager to another. Unlike conventional pet stakes that require a person to perform the timely and often strenuous task of completely removing a conventional pet stake from the ground and reinserting the pet stake into the ground at a different location each time the pet owner chooses to change the pet location, the present invention provides a pet restraint apparatus that enables a pet owner to easily change the location of the leash holder.

It is therefore an advantage of the present invention to provide a pet restraint apparatus which is easily used and reused and which does not interfere with lawn care equipment.

Additional features and advantages of the present invention are described in, and will be apparent from, the following Detailed Description of the Invention and the figures.

### BRIEF DESCRIPTION OF THE FIGURES

FIG. 1A is a greatly enlarged side elevational view of the assembled pet restraint apparatus of one embodiment of the present invention inserted into the ground and illustrating the leash holder engaging the ground engager (shown in cross-section).

FIG. 1B is a side elevational view of the assembled pet restraint apparatus of FIG. 1A holding a dog.

FIG. 2 is a side view of the leash holder of the embodiment of FIG. 1A of the present invention.

FIG. 3 is a side view of the ground engager of the embodiment of FIG. 1A of the present invention.

FIG. 4 is a partially exploded top perspective view of the leash holder, ground engager and mounting plate of the embodiment of the FIG. 1A of the present invention.

### DETAILED DESCRIPTION OF THE INVENTION

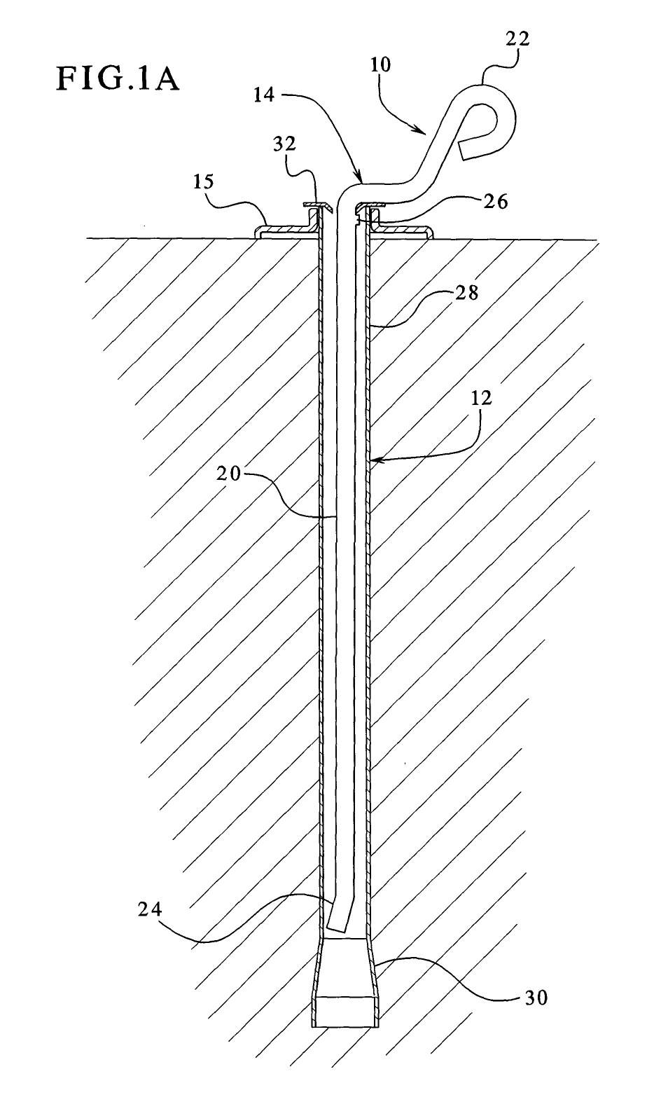

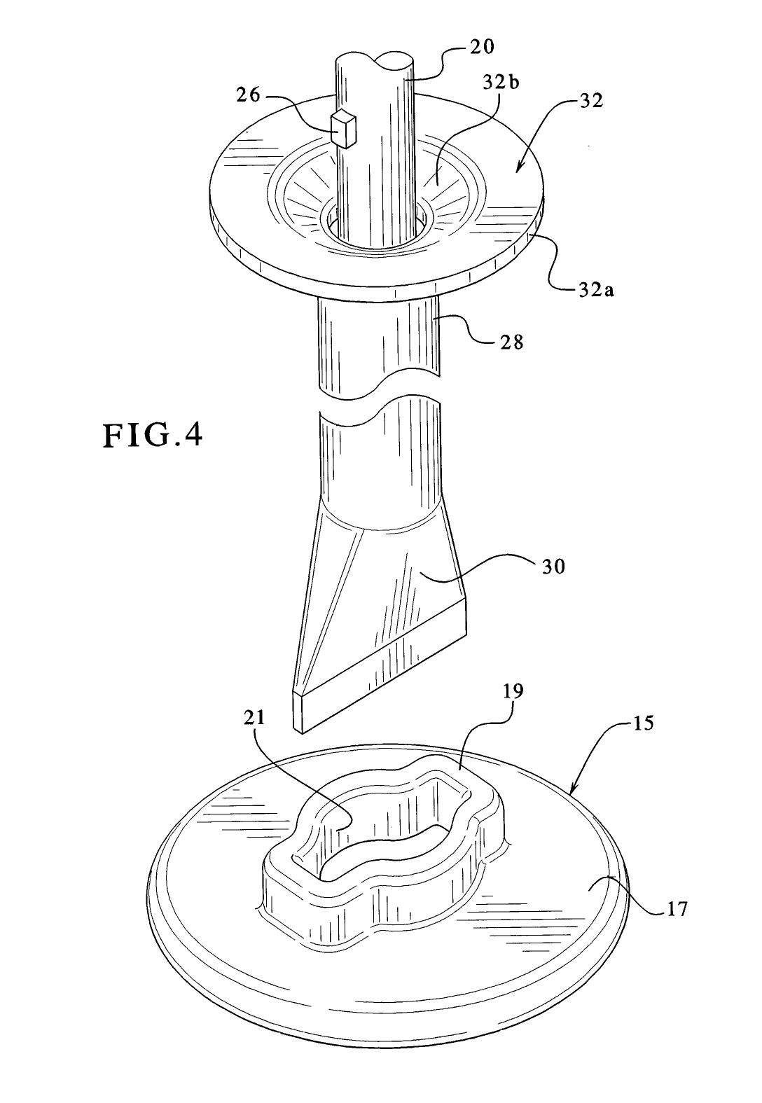

The present invention relates to an apparatus for restraining one or more animals. The pet restraining apparatus is adapted to accommodate any suitable type of animal, and in particular those animals which are considered pets such as dogs. In one embodiment, as illustrated in FIGS. 1A, 1B, 2, 3 and 4, the pet restraint apparatus 10 includes a ground engager 12 and a leash holder 14. In another embodiment as also illustrated in FIGS. 1A and 1B and 4, the pet restraining apparatus also includes a mounting plate 15. The leash holder 14 is adapted to hold a leash 16 or other similar device that is attached to the pet 18. The ground engager 12 is adapted to be removably inserted into the ground. Once inserted into the ground, the ground engager remains in the ground until it is removed by a person. The ground engager is adapted to removably receive and securely hold the leash holder. Once received, the leash holder remains engaged with the ground engager until a person disassembles the pet restraint apparatus by disengaging the leash holder and removing it from the ground engager. By securing the pet's leash to the anchored pet restraint apparatus of the present invention, the pet is enabled to freely move while staying within a predetermined boundary.

As illustrated in FIGS. 1A, 2 and 4, in one embodiment, the leash holder 14 includes a solid body 20, such as an elongated stake or rod. The leash holder includes a leash securing member 22 attached to one end of the body and a centering member 24 attached to the other end of the body. In one embodiment, a release inhibiting member 26 is attached to and extends transversely from the body of the leash holder 14 adjacent to the leash securing member 22. It should be appreciated that the release inhibiting member or release inhibitor 26 could be at other suitable locations of the body 20. In one alternative embodiment, the release inhibiting member is any suitable mechanism, such as a spring-biased squeezable latch, that is operable to engage the retainer or possibly an inner wall of the ground engager.

In one embodiment, the leash securing member 22 includes a loop or other applicable shape that is adapted to be attached to an animal's leash, rope, chain or other leash device. The leash securing member 22 is preferably bent or angled in a direction away from the longitudinal axis of the body 20. When the pet restraint apparatus is assembled, as illustrated in FIGS. 1A and 1B, the leash securing member is adapted to be positioned at a distance above the ground.

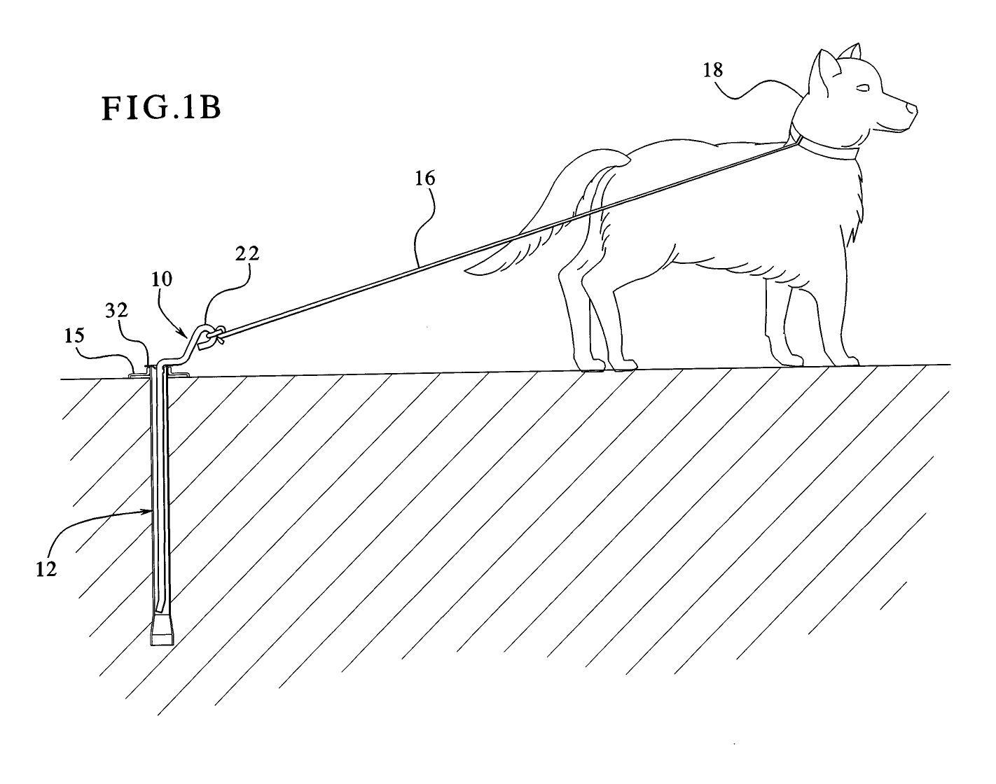

In one embodiment, as seen in FIG. 2, the centering member 24 of the leash holder 14 includes a finger which is bent or angled away from the longitudinal axis of the body in a direction opposite the bend or angle of the leash securing member. As described in more detail below, the centering member 24 is adapted to engage the inner wall of the tubular body of the ground engager 12 when a transverse force is applied to the leash securing member.

In one embodiment, the body, leash securing member, centering member and release inhibiting member may be welded or otherwise suitably attached. In an alternative embodiment, the body, leash securing member, centering member and release inhibiting member are integrally formed from the same material to form the leash holder. In one embodiment, the leash holder is constructed of a stainless steel or cadmium or zinc plated steel. In alternative embodiments, the leash holder may be constructed of any suitable durable material such as metals, ceramics, plastics or a combination thereof. It should be appreciated that while the body of the leash holder is described as an elongated member, any suitable shape or configuration that is capable of being removably inserted into the ground engager may be implemented in accordance with the present invention.

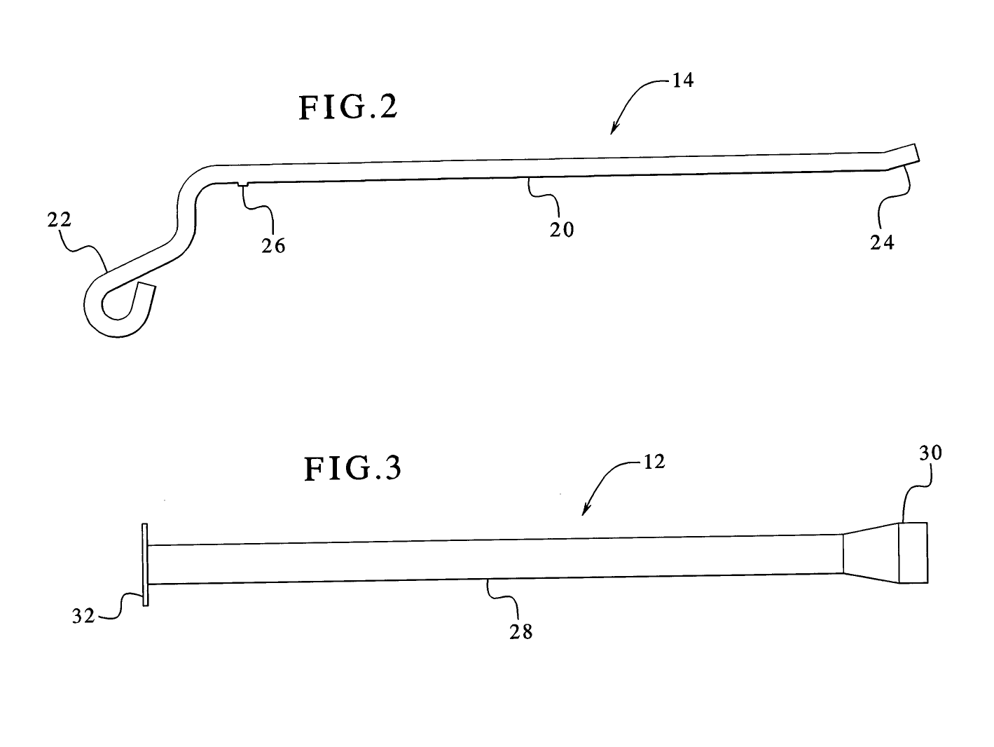

As illustrated in FIGS. 1A, 1B and 3, in one embodiment, the ground engager 12 includes a tubular sleeve or receiver 28 that includes a body, a ground engaging member 30 attached to one end and a washer 32 attached to the other end. The washer defines a stopping member or outer lip and a retainer or inner lip as discussed in more detail below.

In one embodiment, the ground engaging member 30 is crimped, pointed or otherwise suitably formed to enable the ground engaging member and specifically the body of the ground engager to be easily driven into the ground. In this embodiment without using the mounting or locating plate, to assemble the pet restraint apparatus, the ground engager is positioned perpendicular to the ground and a force is applied to the ground engager to drive the ground engaging member into the ground. As the ground engaging member is driven into the ground, the attached body of the ground engager is driven into the ground. This process continues until the stopping member engages the ground. In this embodiment, the stopping member is adapted to control the insertion of the ground engager into the ground to a desired length. That is, the stopping member is adapted to engage the ground and prevent the ground engager from being completely inserted into the ground. Furthermore, the stopping member provides a gripping portion which enables a person to remove the ground engager from insertion into the ground. Once inserted into the ground, the washer end of the ground engager is adapted to receive the centering member followed by the body of the leash holder. That is, the leash holder is adapted to be removably inserted into the ground engager.

In one embodiment, the ground engaging member, body and stopping member may be welded or otherwise suitably attached to form the ground engager. In another embodiment, the ground engaging member, body and stopping member are integrally formed from the same material to form the ground engager. In one embodiment, the ground engager is constructed from stainless steel. The ground engager could alternatively be constructed from a cadmium or zinc plated steel. In another embodiment, a powdered nylon coating or other suitable coating is applied to the steel or stainless steel. In alternative embodiments, the ground engager may be constructed of any durable material such as one or more metals, ceramics or plastics or a combination thereof. It should be appreciated that while the body of the ground engager is described as a tubular member, any suitable shape or configuration that is capable of being inserted into the ground and receiving said leash holder may be implemented with the present invention.

In one embodiment, the washer 32 which is made from a similar material as the tubular member is welded to one end of the body of the ground engager. The washer 32 defines and/or includes an outer lip or flange 32a which functions as stopping member and an inner lip or flange 32b which functions as a retainer. The retainer in this embodiment defines a suitably sized aperture to allow the insertion of the leash holder (including the release inhibiting member extending from the body of the leash holder) into the ground engager. Once inserted, the release inhibiting member engages the bottom of the retainer to prevent the removal of the leash holder from the ground engager when a transverse force is applied to the leash holder. Such a transverse force would be applied when the a pet moves on the ground away from the restraint assembly of the present invention. The leash holder is centered in the ground engager to remove the leash holder from the ground engager.

FIG. 4 best illustrates a further embodiment of the present invention. This embodiment includes a mounting plate 15 adapted to be positioned on the ground prior to insertion of the ground engager. The mounting plate 15 includes a base 17 and a ground engager support 19. The base in the illustrated embodiment is a substantially circular member or disk-shaped member adapted to be positioned on the ground. The ground engager support 19 extends upwardly from the top of the base 17. The stopping member engages the ground engager support when inserted into the ground through the mounting plate. The ground engager support defines a suitably sized opening 21 such that the ground engaging member 30 of the ground engager can be inserted into the ground through the mounting plate. The mounting plate is preferably molded from a suitable plastic, although it could be made in other suitable manners and from other suitable materials

In use and operation, when inserted into the ground engager, the centering member of the leash holder is positioned in the body of the ground engager slightly above the end that is attached to the ground engaging member. This configuration provides that when inserted, the leash holder is freely rotatable within the ground engager so that the pet has a full 360° area in which to move. That is, as the pet moves around the pet restraint apparatus, the leash securing member moves with the pet to prevent entanglement of the leash and the pet restraint apparatus.

It should be appreciated that by attaching the leash securing member and centering member to the body of the leash holder in opposite directions, the configuration of the leash holder provides that regardless of which direction or with what amount of force the leash securing member of the leash holder is being pulled with, the leash holder will remain on the same vertical axis and will not be substantially tilted in one way or the other. That is, because the centering member is bent or extends from the body of the leash holder in a direction opposite of the leash securing member, when the leash securing member is pulled in one direction by the pet, the centering member will engage an inner wall of the body of the ground engager to maintain that the leash holder remains centered on the vertical axis.

If the pet owner desires to use the ground surrounding the pet restraint apparatus, for example, if the pet owner desired to mow the grass around the pet restraint apparatus, the pet owner needs to simply disassemble the pet restraint of the present invention. In one embodiment, to disassemble the pet restraint apparatus, a person would have to align the release inhibiting member with the opening defined by the retainer. The person slides the leash holder out of the ground engager. When the leash holder is removed, the ground engager remains inserted into the ground through the mounting plate and the pet owner can perform the lawn work without damaging the ground engager or mounting plate. When finished, the pet owner slides or otherwise reinserts the leash holder back into the ground engager and the pet restraint apparatus is again ready to restrain a pet. It should be appreciated that in an alternative embodiment, if the present invention is implemented without a release inhibiting member, the leash holder would remain inserted in the ground engager until a person removes the leash holder. That is, as an upward force on the leash holder is required to remove the leash holder from the ground engager and as the pet is only capable of applying a transverse force on the leash holder, the leash holder will remain inserted in the ground engager until a person applies the required upward force to remove the leash holder from the ground engager.

A pet owner may insert a number of ground engagers at different locations throughout their lawn or property and depending on where they are situated, transfer a single leash holder from one ground engager to another. Unlike conventional pet stakes that require a person to perform the task of completely removing the pet stake from the ground and reinserting the pet stake into the ground at a different location each time the pet owner chooses to change the pet's predetermined boundary, the present invention provides a leash holder that enables a pet owner to easily change the pet's predetermined boundary.

The present invention also contemplates a suitably sized locating marker such as post or rod adapted to be inserted into the ground engager to assist a user in locating the ground engager which is not in use.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A pet restraint apparatus comprising:
a ground engager including a ground engager body, a ground engaging member at a first end of the ground engager body and a retainer at a second end of the ground engager body, wherein said ground engager is insertable into the ground; and
a leash holder including a leash holder body, a leash securing member at a first end of the leash holder body and at least one release inhibiting member connected to the leash holder body, wherein the leash holder body removably insertable into the ground engager body, said leash holder body sized to be freely rotatable in said ground engager body, wherein the leash holder includes a centering member extending from the leash holder body of the leash holder and when the leash holder body is in the ground engager body, the release inhibiting member is engageable with the retainer to prevent a removal of the leash holder body from the ground engager body by a transverse force applied to the leash holder.

2. The pet restraint apparatus of claim 1, wherein the ground engager body of said ground engager includes a tubular sleeve.

3. The pet restraint apparatus of claim 1, which includes a stopping member connected to the ground engager body of the around engager and sized to control an insertion of the ground engager into the ground to a desired depth.

4. The pet restraint apparatus of claim 2, wherein the leash holder includes a substantially straight portion engageable with an exterior surface of the stopping member of the around engager.

5. The pet restraint apparatus of claim 4, wherein said centering member is formed to engage an inner wall of the ground engager body of said ground engager when a force is applied to the leash securing member.

6. The pet restraint apparatus of claim 1, wherein said retainer defines an aperture sized to allow said release inhibiting member of the leash holder to disengage the retainer to remove the leash holder from the ground engager.

7. The pet restraint apparatus of claim 1, wherein said leash securing member is formed to receive at least one leash.

8. (cancelled)

9. The pet restraint apparatus of claim 1, which includes a mounting plate adapted to receive the ground engager.

10. The pet restraint apparatus of claim 9, wherein the mounting plate includes a base and a ground engager support extending from the base.

11. A pet leash holder insertable into a ground engager, said ground engager insertable into a section of ground and including a tubular around engager body, a ground engaging member at one end of the ground engager body and a retainer, said pet leash holder comprising:
a leash holder body;
a leash securing member at a first end of said leash holder body, said leash securing member angled away from the leash holder body in a first direction; and
a release inhibiting member extending from said leash holder body which is engageable with the retainer when the leash holder body is in the ground engager body to prevent said leash holder body from disengaging said ground engager body when a transverse force is applied to said leash securing member and wherein the leash holder body is sized to freely rotate within said ground engager body and wherein the leash holder includes a center member extending from the leash holder body and engageable with an interior surface of the ground engager body.

12. (cancelled)

13. The pet leash holder of claim 11, wherein the centering member at a second end of said leash holder body is angled away from the leash holder body in a second direction which is substantially opposite the first direction.

14. A pet restraint ground engager in which a leash holder is receivable, wherein said leash holder includes a leash holder body, a leash securing member, a centering member and a release inhibiting member, said pet restraint ground engager comprising;
a tubular body sized relative to the leash holder body such that the leash holder body is freely rotatable in said tubular body when the leash holder body is in said tubular body, and wherein said centering member is engageable with an inner surface of the tubular body;
a ground engaging member at a first end of the tubular body, said ground engaging member insertable into a section of ground; and
a retainer at a second end of the tubular body, said retainer formed to control a disengagement of the leash holder from the tubular body.

15. The pet restraint ground engager of claim 14, wherein said ground engaging member is crimped.

16. The pet restraint ground engager of claim 14, wherein said ground engaging member is pointed.

17. The pet restraint ground engager of claim 14, which includes a stopping member at a second end of the leash holder body opposite the ground engaging member.

18. The pet restraint ground engager of claim 14, wherein the retainer is sized to engage the release inhibiting member when a transverse force is applied to said leash securing member.
